(19) United States
(12) Patent Application Publication
(10) Pub. No.: US 2025/0229270 A1
(43) Pub. Date: Jul. 17, 2025

(54) MICROFLUIDIC DEVICE WITH RECTIFYING FUNCTION

(71) Applicant: ibidi GmbH, Gräfelfing (DE)

(72) Inventors: Zeno von Guttenberg, Gräfelfing (DE); Lea Tomasova, Gräfelfing (DE)

(21) Appl. No.: 19/017,334

(22) Filed: Jan. 10, 2025

(30) Foreign Application Priority Data
Jan. 16, 2024 (DE) 102024101101.7

(51) Int. Cl. B01L 3/00

(52) U.S. Cl. CPC B01L 3/502738; B01L 2300/047; B01L 2300/0663; B01L 2300/0858; B01L 2300/087; B01L 2400/0622; B01L 2400/0638

(57) ABSTRACT

A microfluidic device includes a rectifier unit, which includes a substrate, a valve assembly formed in the substrate, and a fluid channel arrangement formed in the substrate. The fluid channel arrangement comprises a first inlet opening, a second inlet opening, a first rectifier opening and a second rectifier opening. The valve assembly can be brought from a first state into a second state, wherein in the first state a liquid can be conveyed from the first inlet opening to the first rectifier opening and from the second rectifier opening to the second inlet opening, and wherein in the second state the liquid can be conveyed from the second inlet opening to the first rectifier opening and from the second rectifier opening to the first inlet opening. The valve assembly comprises four valves, one of which is an umbrella valve having a through-hole formed under the umbrella of the umbrella valve, the through-hole being covered by the umbrella in a blocking state of the valve.

### RELATED APPLICATIONS

The present application claims the benefit under 35 U.S.C. § 119 (a) of German patent application 102024101101.7, filed Jan. 16, 2024, which is incorporated by reference herein.

### TECHNICAL FIELD

The present invention relates to a microfluidic device for rectifying a liquid flow, a system comprising the microfluidic device, and an associated method.

### BACKGROUND

In a variety of microbiological applications, liquids are conducted through a microfluidic system for examining biofilms and cell aggregates or for examining the behavior of cells under continuous flow conditions. For this purpose, the cells can be present in a reservoir on a chip or in a substrate, and the substrate is connected to the microfluidic system, which is used for conducting the liquid through the reservoir. This set-up is used, for example, in arteriosclerosis research in connection with the adhesion behavior of cells, or in the simulation of organ models, where physiological conditions such as those in an organ (e.g. intestine) are imitated on a microfluid chip. A substrate or a chip with such a reservoir can be placed in an incubator and cultured there. It is particularly important for these examinations and simulations that a continuous, unidirectional flow of the fluid is achieved, for which e.g. the valve assembly according to EP 1 944 084 A1 was developed.

In addition, the cells can be observed continuously under a microscope. To this end, all components, i.e. the substrate with the cells and the microfluidic system, must be incubated, so as to create controlled and stable ambient conditions. This has hitherto only been possible with the aid of bulky or separate incubators for the individual components. One disadvantage of separate components is that hose connections between the microfluidic system and the substrate are routed through an intermediate area at room temperature, which may lead to bubble formation in the hoses due to a temperature gradient. Further disadvantages of such a set-up are the complexity of the system and the high dead volume created by the hose connections.

Bubbles may form in the microfluidic system, for example at sharp edges, and may be retained in the valve area. Such bubbles are disadvantageous for the described examinations because, due to the interruption of the fluid flow, they may lead to non-physiological culturing conditions and the examination may therefore be falsified.

### SUMMARY

Taking the above into account, a microfluidic device in which a fixation of bubbles in the valve area is suppressed would be desirable.

Hence, it is an object of the present invention to provide a microfluidic device having a rectifying function and a method of generating a unidirectional flow, which allow a compact set-up of a cell examination device and suppress the formation of bubbles when a liquid is being transported through a microfluidic device.

### BRIEF DESCRIPTION OF THE FIGURES

Additional features and advantages will be explained hereinafter on the basis of the exemplary Figures, in which:

FIG. 1 shows the schematic cross-sectional view looking at the upper side of a microfluidic device;

FIG. 2 shows the schematic cross-sectional view looking at the lower side of a microfluidic device according to FIG. 1;

FIG. 3A shows the schematic representation of a closed umbrella valve in cross-section;

FIG. 3B shows the schematic representation of an open umbrella valve in cross-section;

FIG. 4 shows the schematic cross-sectional view looking at the upper side of further microfluidic device;

FIG. 5 shows the schematic cross-sectional view looking at the lower side of a microfluidic device according to FIG. 4;

FIG. 6 shows the schematic representation of a microfluidic system; and

FIG. 7 shows a schematic cross-sectional view of a supply unit.

### DETAILED DESCRIPTION

According to embodiments of the present invention, a microfluidic device is provided, which comprises a rectifier unit. The rectifier unit comprises a substrate, a valve assembly formed in the substrate, and a fluid channel arrangement formed in the substrate. The fluid channel arrangement comprises a first inlet opening and a second inlet opening, a first rectifier opening and a second rectifier opening, and a channel system, wherein the channel system fluidically connects the first inlet opening via the valve assembly to the first rectifier opening and fluidically connects the second inlet opening via the valve assembly to the second rectifier opening, or wherein the channel system fluidically connects the first inlet opening via the valve assembly to the second rectifier opening and fluidically connects the second inlet opening via the valve assembly to the first rectifier opening, wherein the valve assembly can be brought from a first state into a second state, wherein in the first state a liquid can be conveyed from the first inlet opening to the first rectifier opening and from the second rectifier opening to the second inlet opening, and wherein in the second state the liquid can be conveyed from the second inlet opening to the first rectifier opening and from the second rectifier opening to the first inlet opening, wherein the valve assembly comprises four valves, one of which is an umbrella valve having a through-hole formed under the umbrella of the umbrella valve, the through-hole being covered by the umbrella in a blocking state of the valve.

The structural design of the rectifier unit comprising the fluid channel arrangement and the valve assembly in one substrate constitutes a compact design of the microfluidic device, so that the microfluidic device can flexibly be combined with other components as well. In addition, an umbrella valve having the through-hole formed under the umbrella has the property that, in comparison with other types of valves, for example a check valve with a conical seat and a ball, a disadvantageous fixation of bubbles is suppressed.

The first inlet opening and the second inlet opening serve to supply and discharge liquid into the rectifier unit. A flow direction at the two rectifier openings is independent of whether the liquid is supplied at the first inlet opening or at the second inlet opening. The liquid is conducted in the fluid channel arrangement such that it will always flow from the location of liquid supply (first or second inlet opening) to the first rectifier opening. From the second rectifier opening, the liquid then flows to the other of the inlet openings that is not used for liquid input.

The total effect achieved is that the rectifier unit is able to provide a unidirectional flow between the two rectifier openings.

The channel system formed in the substrate serves to connect the openings of the microfluidic device, as mentioned above (first and second inlet openings, first and second rectifier openings), to one another. The channel system may comprise one channel or a plurality of channels, as long as the specified purpose remains fulfilled. A channel refers, in particular, to a cavity formed in the substrate.

An umbrella valve comprises a flexible or elastic umbrella that covers the through-hole arranged under the umbrella. Liquid can flow through this through-hole. When the liquid flows through the through-hole and impinges on the side of the umbrella facing the through-hole, the liquid pressure will cause the umbrella to open, whereupon the liquid can flow past the umbrella valve. The umbrella valve is in an open state and the flow is therefore not blocked. When the liquid moves/flows in the direction of the through-hole from a side of the umbrella facing away from the through-hole, the liquid pressure will cause the umbrella to be pressed onto the through-hole, and the through-hole will be sealed in a liquid-tight manner. The umbrella valve is in a blocking state and the flow of liquid through the valve is therefore blocked.

The umbrella valve, in particular the umbrella, may comprise an elastomer material, such as silicone, liquid silicone rubber, fluorosilicone, nitrile rubber or neoprene.

All the valves of the valve assembly may be passive valves, in particular passive check valves, which are opened and closed exclusively by the pressure of the liquid flowing in the fluid channel arrangement. One umbrella valve is a passive check valve. If all valves are passive valves, the valve assembly is self-controlled, i.e. it can be brought from the first state into the second state, and vice versa, solely by the pressure of the flowing liquid.

One, a plurality of, or all of the above-mentioned openings may additionally have a connection associated therewith. The connection or connections at the respective channel end may satisfy the Luer standard, which means that the connections may preferably have a female Luer or Luer-lock adapter. By using connections that satisfy the Luer standard, the connections can be connected easily and in a liquid-tight manner. In addition, the microfluidic device is thus compatible with numerous devices.

The channel system may be formed in a first plane and a second plane, the first plane being defined parallel to the second plane, and the first plane and the second plane being fluidically connected to each other by at least one of the valves of the valve assembly. The first plane and the second plane may also be parallel to a lower side and/or an upper side of the substrate. In addition, it is conceivable that the first plane and the second plane are fluidically connected to each other by one or more through-holes through the substrate.

The use of two parallel planes allows a more compact structural design of the channel system, in particular in combination with one or a plurality of umbrella valves. Since the umbrella valve fluidically connects the two planes to each other, the umbrella of the umbrella valve is located in the plane of the channels. This means that a lower height of the substrate is required, compared to the case where the umbrella is arranged e.g. perpendicular to the plane of the channels.

Each valve of the valve assembly may be an umbrella valve.

As explained above, an umbrella valve can reduce the fixation of bubbles. Insofar, it is particularly advantageous to use exclusively umbrella valves, because this will further suppress the blocking of the flow of liquid by bubbles.

Two of the valves may be configured to block a flow from the first plane into the second plane and the other two of the umbrella valves may be configured to block the flow from the second plane into the first plane.

This arrangement of the valves represents a simple way of realizing a fluid channel arrangement with a valve assembly, which achieve the desired rectifier function. However, this need not be the only possible configuration. One advantage of the umbrella valves becomes here apparent insofar as, by changing the blocking direction of the flow (from the first plane to the second plane or vice versa), also the function of the microfluidic device can easily be changed or adapted.

Precisely two, three, four or five through-holes may be arranged under the umbrella of the umbrella valve or rather of each of the umbrella valves, the cross-section of these through-holes corresponding in particular to a circular ring segment with rounded corners. This kind of cross-sectional shape will also be referred to as kidney-shaped in the following.

Experiments have shown that small through-holes lead to increased bubble fixation. Therefore, not more than five individual through-holes should be provided for each of the umbrella valves in order to effectively suppress bubble fixation. Furthermore, it will be advantageous when the through-holes as a whole make up as large an area as possible under the umbrella. For this purpose, the through-holes may have a cross-sectional shape that corresponds to a circular ring segment with rounded corners. The rounded corners reduce the risk of bubble formation at sharp edges. The cross-section is considered to be that area of the through-holes that is perpendicular to the flow direction of the liquid through the through-holes.

In the microfluidic device described, the length of a channel system portion connecting the first inlet opening to the first rectifier opening may be identical to the length of a channel system portion connecting the second inlet opening to the second rectifier opening, and/or the length of a channel system portion connecting the first inlet opening to the second rectifier opening may be identical to the length of a channel system portion connecting the second inlet opening to the first rectifier opening.

In the microfluidic device described, the cross-sectional area of a channel system portion connecting the first inlet opening to the first rectifier opening may be identical to the cross-sectional area of a channel system portion connecting the second inlet opening to the second rectifier opening, and/or the cross-sectional area of a channel system portion connecting the first inlet opening to the second rectifier opening may be identical to the cross-sectional area of a channel system portion connecting the second inlet opening to the first rectifier opening.

A channel system in which the channel portions described are identical in length and have the same cross-sectional area has a higher degree of symmetry. For example, the distance between the first inlet opening and the first rectifier opening is the same as between the second inlet opening and the first rectifier opening. This has the effect that, regardless of which inlet opening has the liquid supplied thereto, possible external influences will have the same effect and the liquid exiting at the first rectifier opening will always have the same properties. When a flow chamber is connected to the rectifier openings, the liquid flowing through the flow chamber will thus have constant properties (e.g. temperature, gas concentration, etc.), regardless of which of the inlet openings has the liquid supplied thereto. Nor can there be any differences in transit time in the case of the two different switching states of the microfluidic system, which could lead to a transport of different volumes.

The microfluidic device may further comprise a supply unit with a first liquid reservoir and a second liquid reservoir, wherein the first inlet opening is fluidically connected to the first liquid reservoir and the second inlet opening is fluidically connected to the second liquid reservoir.

The two liquid reservoirs serve, in this case, to provide liquid that is to be conducted through the microfluidic device. If the supply unit is now provided as part of the microfluidic device, it will not be necessary to provide the liquid from outside, and the microfluidic device can be operated as a closed system. This will also effectively suppress any contamination of the liquid from outside.

Another advantage of this microfluidic device is that a unidirectional flow is achieved by pumping the liquid back and forth between the first liquid reservoir and the second liquid reservoir. The amount of liquid required is therefore small and no liquid is consumed. This is advantageous compared to the case where the liquid would always be supplied at the same inlet opening, because, depending on the operating mode and duration, large amounts of liquid are needed in the latter case.

The first liquid reservoir and/or the second liquid reservoir may be formed on or in the substrate of the rectifier unit. This leads to a particularly compact set-up of the microfluidic device. In addition, the connections between the first liquid reservoir and the first inlet opening, and between the second liquid reservoir and the second inlet opening, may be configured, at least partially, in the form of a channel in the substrate. This aspect has the advantage that no hose connections are required and that the transport distances of the liquid can be shortened. As a result, the liquid is less likely to be exposed to a temperature gradient, and this will decrease the risk of bubble formation in the liquid and the volume of liquid required for perfusion in the microfluidic device will be reduced. Alternatively, the two liquid reservoirs may be formed on or in a separate supply substrate. This allows for greater freedom in the composition of the microfluidic device, making it thus more flexible in use.

The first liquid reservoir and/or the second liquid reservoir may additionally comprise a line that extends from the outside into the interior of the respective liquid reservoir, the line extending in particular through a cover or through a sidewall of the respective liquid reservoir.

The purpose of this kind of design of the liquid reservoirs is that gas in particular can be conducted from the outside into the liquid, provided that the line projects into the liquid contained in the liquid reservoirs. This allows the content of a particular gas in the liquid (e.g. oxygen) to be adjusted efficiently. A concrete design of this will be explained hereinafter.

The microfluidic device may further comprise a flow chamber, the flow chamber comprising an inlet and an outlet, and the inlet of the flow chamber being fluidically connected to the first rectifier opening while the outlet of the flow chamber is fluidically connected to the second rectifier opening.

According to embodiments of the described device, the liquid flows through the connected flow chamber in a predetermined direction (from the inlet to the outlet), regardless of whether the liquid is supplied at the first inlet opening or at the second inlet opening. The flow chamber can be used as a cell culture chamber that is perfused unidirectionally by the liquid. The microfluidic device, including the cell culture chamber, is therefore configured to culture cell cultures under a unidirectional flow. The above described advantages of the microfluidic device still apply.

The flow chamber may also include a porous membrane that divides the flow chamber into a first area and a second area, with the inlet and the outlet being fluidically connected to the first area. The porous membrane is here in particular permeable to the liquid.

This kind of set-up allows the simulation of systems in which a concentration gradient of gas dissolved in a liquid exists. In this respect, the flow chamber, in which both areas are filled with liquid, will be considered. The liquid flowing through the first area has a certain concentration of gas, in particular oxygen. In the second area, a different oxygen concentration may exist. If the two areas have oxygen concentrations that differ from each other, a diffusive exchange will take place through the porous membrane and the oxygen concentrations in the two areas will slowly become equal.

A possible example of use is the simulation of an intestinal model. In the intestine, a hypoxic regime with reduced oxygen concentration (<21%) exists. The surrounding blood vessels, however, have a normal oxygen concentration of about 21%. The transport processes between the intestine and the blood vessels can now be simulated and examined in a realistic way by means of the flow chamber unit in a compact and simplified set-up.

The flow chamber may be formed in the substrate of the rectifier unit.

The entire microfluidic device can be designed compactly in this way, since both the flow chamber and the rectifier unit are provided on or in a joint substrate. This is also advantageous for easy handling, because it is not necessary to connect a plurality of individual components. Furthermore, the connection between the first rectifier opening and the inlet, as well as between the second rectifier opening and the outlet, can be configured, at least partially, in the form of a channel in the substrate. As explained above, this aspect will reduce the risk of bubble formation in the liquid as well as the volume of liquid required for perfusion.

Alternatively, the flow chamber may be formed in a separate substrate. Likewise, it is possible that the flow chamber is formed, together with the first and the second liquid reservoir, in a substrate separate from the rectifier unit.

Furthermore, a sensor for measuring an oxygen concentration of the liquid may be provided. The sensor will therefore also be referred to as oxygen sensor in the following.

The oxygen sensor may be arranged inside the flow chamber, it may e.g. be glued on. The oxygen sensor can be read optically from outside because the sensor exhibits a change in fluorescence depending on the oxygen concentration of the liquid. Insofar, the sensor may be an optically readable sensor.

The oxygen sensor may also be used for controlling the oxygen concentration in the liquid. To this end, the oxygen sensor is connected to a gas mixer via a feedback loop. The gas mixer may be configured to generate a gas mixture containing particular percentages of individual gases (e.g. oxygen, nitrogen, carbon dioxide, etc.) and to introduce the gas mixture into one or both of the liquid reservoirs via a connection. The feedback loop is used for determining which percentages of the gases need to be mixed so that the liquid will have a predefined oxygen concentration. This process can be carried out continuously.

The rectifier unit described may be configured as a multipart unit. In this case, the substrate comprises a bottom plate, a cover plate and a center plate, wherein the lower side of the center plate facing the bottom plate has formed therein at least one trench and wherein the upper side of the center plate facing the cover plate has formed therein at least one trench, wherein the bottom plate and the center plate as well as the cover plate and the center plate are areally connected to one another, so that the trench in the upper side is covered by the cover plate and the trench in the lower side is covered by the bottom plate, and wherein the covered trenches are part of the fluid channel arrangement and of the channel system, respectively.

A subdivision into three individual units that are connected to form a microfluidic device will simplify the manufacture of the microfluidic device. For example, the center plate can be produced by injection molding, which is a simple, precise and cost-effective manufacturing method. Whereas injection molding cannot easily be used for forming cavities in a component to be manufactured, the formation of trenches covered by the cover plate and the bottom plate, respectively, on an upper side and a lower side of the center plate provides a simple alternative for obtaining an equivalent microfluidic device.

The substrate may include or consist of a plastic. In particular, it may comprise plastics such as COC (cyclo-olefin copolymer), COP (cyclo-olefin polymer), PC (polycarbonate), PS (polystyrene), PE (polyethylene), PMMA (polymethyl methacrylate) or a transparent thermoplastic or elastomer.

The substrate may have been manufactured by injection molding. By using the materials and processes mentioned, the microfluidic devices can be produced at low cost and in large numbers with consistent quality. This is because injection molding with plastics is an established and reliable process and can in particular be used in the case of the plastics referred to.

Alternatively, the substrate may comprise glass.

The glass or the plastic may exhibit the birefringence and the autofluorescence of a Schott coverslip (such as D 263 M Schott glass, No. 1.5H (170+/−5 μm)).

A material of high optical quality can allow for microscopic examinations with high precision and little optical imperfections.

The center plate may have a thickness between 0.5 mm and 2 cm, in particular between 0.5 mm and 5 mm. The thickness means here the distance between the upper side and the lower side of the center plate. The bottom plate may have a thickness between 1 μm and 2 mm, in particular between 1 μm and 300 μm. As regards the thickness of the bottom plate, an analogous definition is to be used. The explanations concerning the bottom plate apply in an analogous manner to the cover plate. The external dimensions of the substrate may be 25 mm by 75 mm or 85.4 mm by 127.6 mm.

The cover plate may comprise a first film, and/or the bottom plate may comprises a second film. In particular, the cover plate and/or the bottom plate may be transparent in the visible spectral range.

The first film and/or the second film may include or consist of the above-mentioned plastics. The first film and/or the second film may have a refractive index of 1.5, a minimal autofluorescence and/or a minimal birefringence. A thickness of the first film and of the second film may be in the range of 1 μm and 300 μm.

The cover plate in the form of a first film may be attached to the center plate by welding, e.g. ultrasonic welding or solvent welding. Likewise, it is conceivable to use gluing, e.g. by means of dispersion adhesives or an adhesive film (double-sided adhesive film). The same considerations also apply to the bottom plate in the form of the second film.

The bottom plate and the center plate, as well as the cover plate and the center plate, are connected to one another in such a way that the optical properties of the substrate and, consequently, of the microfluidic device are preserved and e.g. microscopy, in particular fluorescence microscopy or inverse microscopy, can be carried out with the microfluidic device. At the same time, these methods are established in connection with plastic components and represent a cost-effective and efficient way of attaching the bottom plate and the cover plate to the center plate.

The transparency of the first and/or the second film may be a prerequisite for allowing microscopy to be carried out at the microfluidic device.

A small thickness of the bottom plate and/or the cover plate in the specified range has the advantage that, in the case of inverse microscopy, the objective can be moved particularly close to an area to be observed in the microfluidic device (in the substrate). This allows improved optical resolution.

The microfluidic device may further comprise a compressed air unit that is fluidically connected to the first liquid reservoir and the second liquid reservoir, the compressed air unit being configured to provide compressed air, so that the liquid can be pumped from the first liquid reservoir through the fluid channel arrangement in the direction of the second liquid reservoir, and in the opposite direction.

The compressed air unit may be, or include, an air pressure pump, a piston pump, a diaphragm pump, a peristaltic pump, a syringe or a syringe pump, so as to apply compressed air to the first and/or the second liquid reservoir. The term pressure means here overpressure as well as negative pressure. In the case of a negative pressure, the liquid would consequently be sucked in.

The use of a compressed air unit, which is physically separated from a liquid circuit in the microfluidic system between the first liquid reservoir and the second liquid reservoir by an air column, has the advantage that the liquid does not come into contact with parts of the compressed air unit. This would be the case, for example, if a liquid pump were used for delivering the liquid. A potential contamination of the liquid can be avoided in this way.

The present invention additionally provides a microfluidic system. The latter comprises the above-described microfluidic device and an incubator, the microfluidic device being arranged inside the incubator in such a way that a liquid circuit of the microfluidic device is located fully inside the incubator. The liquid circuit may be defined between the first inlet opening and the second inlet opening or between the first liquid reservoir and the second liquid reservoir.

In other words, this means that the liquid remains exclusively within the incubator and that no additional liquid is supplied from outside. The liquid is conveyed and pumped, respectively, by means of compressed air through the compressed air unit.

The compressed air unit may optionally be located outside the incubator, so that, for example, an unwanted rise in temperature inside the incubator due to waste heat from the compressed air unit can be prevented. A gas-filled hose can be used for establishing a connection between the compressed air unit and the supply unit, e.g. via an interface or through an outer wall of the incubator.

An arrangement of this kind, in which the entire liquid circuit is located inside the incubator, is advantageous because bubble formation in the liquid, which may otherwise occur due to a temperature gradient, is prevented. Furthermore, the rectifier unit, the flow chamber and the supply unit can be stored in the incubator under predetermined ambient conditions. This allows in particular living cells to be cultured and examined in the flow chamber in an advantageous manner.

Furthermore, the present invention comprises a method comprising the following steps: providing a microfluidic device according to the above description, supplying a liquid at the first inlet opening and pumping the liquid through the fluid channel arrangement in the direction of the second inlet opening, and reversing the direction of pumping by pumping the liquid through the fluid channel arrangement in the direction of the first inlet opening.

For supplying the liquid at the first inlet opening, the valve assembly is brought into the first state and, for reversing the direction of pumping, the valve assembly is brought into the second state.

This method makes it possible to generate a unidirectional flow, while allowing a compact set-up of a cell examination device and suppressing the formation of bubbles when a liquid is being transported through a microfluidic device or a system comprising the microfluidic device.

The supply of liquid and the reversal of the direction of pumping can be controlled by means of compressed air.

As has already been described in connection with the microfluidic device, the use of compressed air for delivering the liquid has the advantage that the liquid does not come into contact with parts of a compressed air unit. A potential contamination of the liquid can be avoided in this way.

The method may additionally comprise the step of incubating the microfluidic device in an incubator, the microfluidic device being arranged in the incubator such that a liquid circuit of the device is located fully inside the incubator. This means that the liquid remains exclusively within the incubator and that no additional liquid is supplied from outside. As has already been described in connection with the system, this method can be used for examining in particular living cells in an advantageous manner.

Moreover, the present invention provides a supply unit comprising: a substrate with a first liquid reservoir formed on or in the substrate and a second liquid reservoir formed on or in the substrate, each of the liquid reservoirs comprising a supply line, and each of the first liquid reservoir and/or the second liquid reservoir comprising a line that extends from the outside into the interior of the respective liquid reservoir.

This design of a liquid reservoir offers a possibility of influencing the properties of the liquid in the liquid reservoir and, if applicable, in the microfluidic system. One possible use, for example, is to conduct a gas through the line into the interior of the respective liquid reservoir. If a liquid is present in the respective liquid reservoir and the line projects into the liquid, the gas will be conducted into the liquid and the gas content of the liquid will be influenced in this way. In addition, the gas content of the liquid can be adjusted more easily and more precisely than if the gas were present only above the liquid. This aspect will be explained more precisely hereinafter.

The line may, for example, be a rigid tube or a flexible hose. Likewise, the line may be composed of a rigid tube and a flexible hose.

The line may extend through a cover or a sidewall of the respective liquid reservoir into the interior of the latter.

The supply line(s) of one or of both liquid reservoirs may be formed in the substrate. In particular, the supply lines may be configured, at least partially, in the form of a channel in the substrate.

This aspect has the advantage that no hose connections are required and that the transport distances of the liquid can be shortened. As a result, the liquid is less likely to be exposed to a temperature gradient, which decreases the risk of bubble formation in the liquid,

The oxygen sensor may be arranged inside the flow chamber, it may e.g. be glued on. The oxygen sensor can be read optically from outside because the sensor exhibits a change in fluorescence depending on the oxygen concentration of the liquid. Insofar, the sensor can be an optically readable sensor.

Furthermore, a sensor for measuring an oxygen concentration of the liquid may be provided. The sensor will therefore also be referred to as oxygen sensor in the following. The oxygen sensor may be an optical sensor. It may be arranged within one of the liquid reservoirs, e.g. be fastened by means of gluing. The oxygen sensor may exhibit a change in fluorescence depending on the oxygen concentration of the liquid. The oxygen sensor can be read optically and the oxygen concentration of the liquid can be measured accordingly. Insofar, it can be an optically readable sensor. As will be explained in the following, the oxygen concentration in the liquid can, with the aid of the sensor, additionally be used for feedback control and/or simulation.

In addition, a supply system is provided, comprising the described supply unit and a gas source which comprises a gas mixer. The gas mixer is configured to generate a gas mixture containing particular percentages of individual gases (e.g. oxygen, nitrogen, carbon dioxide, etc.). The gas mixture is conducted into the interior of the respective liquid reservoir via a gas connection and the line.

This system offers the above-described possibility of realistically simulating complex systems in a compact and simplified set-up.

The supply unit can be used together with the above-described microfluidic device. Likewise, the supply system can be combined with the microfluidic system.

In the following and in the Figures, the same reference numerals will be used for identical or corresponding elements in the various embodiments, unless otherwise specified.

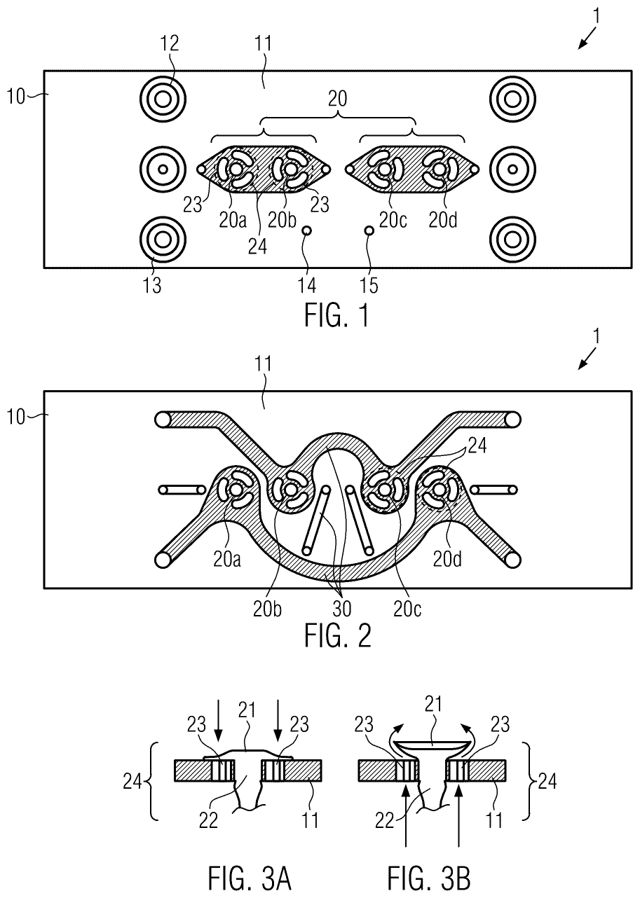

FIG. 1 illustrates a first embodiment of a microfluidic device 1 as a cross-sectional view, so that an upper side of the microfluidic device 1 is illustrated. The microfluidic device 1 comprises a rectifier unit 10. As will be explained in more detail below, the rectifier unit 10 is configured to generate a unidirectional flow, irrespectively of the inlet opening to which a liquid is supplied. The rectifier unit 10 comprises a substrate 11 having a valve assembly 20 and a fluid channel arrangement arranged therein. The design of the valve assembly 20 and the fluid channel arrangement will now be explained in detail.

White framed areas represent through-holes that extend from the lower side to the upper side of the substrate 11. Framed hatched areas are wells or trenches formed in the upper side (and in the lower side, respectively, cf. FIG. 2). The microfluidic device may have a multipart design and the substrate may comprise a bottom plate, a center plate, and a cover plate. For simplicity's sake, only the center plate is shown in the figures. The cover plate and the bottom plate may be a film that is welded or glued to the center plate. As a result, the trenches/wells in the center plate are covered by the bottom plate and the cover plate, respectively, and channels are formed accordingly.

As regards the welding, solvent welding or ultrasonic welding may be used. As regards the gluing, dispersion adhesives or adhesive films, such as double-sided adhesive films, may be used.

In this sense, the channel system 30 comprises two planes and the channel system is arranged in two planes. The first plane is defined by the trenches formed in the upper side of the center plate. The second plane is defined by the trenches formed in the lower side of the center plate. The two planes are fluidically connected to each other by at least one of the valves in the valve assembly 20. Likewise, the through-holes fluidically connect the two planes to each other.

The fluid channel arrangement comprises a first inlet opening 12 and a second inlet opening 13. Both inlet openings can be used for supplying a liquid to the fluid channel arrangement. The fluid channel arrangement additionally comprises a first rectifier opening 14 and a second rectifier opening 15. A channel system is formed/arranged between these four above-mentioned openings (cf. FIG. 2). The channel system connects the first inlet opening 12 via the valve assembly 20 fluidically to the first rectifier opening 14, and the second inlet opening 13 via the valve assembly fluidically to the second rectifier opening 15, or the channel system 30 connects the first inlet opening 12 via the valve assembly 20 fluidically to the second rectifier opening 15, and the second inlet opening 13 via the valve assembly 20 fluidically to the first rectifier opening 14. In other words, this means that the liquid will always exit at the first rectifier opening 14, regardless of whether the liquid is supplied at the first inlet opening 12 or the second inlet opening 13.

The valve assembly 20 comprises four valves 20a, 20b, 20c, 20d. At least one of these valves is an umbrella valve, all four valves 20a, 20b, 20c, 20d are umbrella valves in the present case. The two valves 20a and 20b are arranged in such a way that the umbrella is located on the upper side shown (indicated by dashed lines). There are three through-holes 23 under the umbrella, the cross-section of which has the shape of a circular ring segment with rounded corners. The round center hole is intended to be used for fastening the respective umbrella valve (cf. FIG. 3 and the associated description). Inspired by a human kidney, this cross-sectional shape of the three through-holes 23 of each valve is also referred to as kidney-shaped.

FIG. 2 now shows a cross-sectional view looking at the lower side of the microfluidic device 1 according to the first embodiment. On the lower side, or rather the lower side of the center plate, channels in the form of trenches are formed. These trenches together form the channel system 30. In addition, the two umbrella valves 20c and 20d are arranged such that the respective umbrella is on the lower side (indicated by dashed lines).

An intended use of this rectifier unit 10 will now be explained in more detail. In addition to the first inlet opening 12 and the second inlet opening 13, the rectifier unit 10 comprises also four further openings, which are not specified in detail and which serve the purpose of flushing and filling the fluid channel arrangement with liquid before using the microfluidic device 1. As regards the rectifier function as such, these additional openings have no function. Before use, these four additional openings are sealed in a liquid-tight manner. The additional openings can be used for cleaning the fluid channel arrangement and for making it free from air.

When liquid is now supplied at the first inlet opening 12, it is initially conducted on the lower side in the channel system 30 and passes through the valve 20b to the upper side (the valve 20c is closed because the liquid pressure presses the umbrella onto the through-holes, thus blocking the flow). From there, the liquid passes on to the rectifier opening 14, because the valve 20a is closed (blocked) (umbrella on the upper side). When, conversely, the liquid is supplied at the second inlet opening 13, it passes through the valve 20a and also arrives at the first rectifier opening 14 because the valve 20b is closed (umbrella on the upper side). When a flow chamber is connected to the two rectifier openings 14, 15, the liquid, after having passed through the flow chamber, will return to the rectifier unit 10 through the second rectifier opening 15. When the liquid is supplied at the first inlet opening 12, the valve 20c is held closed by the liquid pressure and the liquid flows through the valve 20d and the channel system 30 to the second inlet opening 13. Conversely, the liquid will be conducted from the second rectifier opening 15 to the first inlet opening 12 through the valve 20c, when the liquid is originally supplied at the second inlet opening 13.

This makes clear how the rectifier unit 10 can provide a unidirectional flow, regardless of whether the liquid is supplied at the first inlet opening 12 or the second inlet opening 13. The use of umbrella valves with the through-holes 23 arranged under the umbrella suppresses the disturbing fixation of bubbles in the liquid, and this allows in particular physiological conditions for cell culturing. In addition, the arrangement of all components of the rectifier unit 10 in one substrate 11 represents a compact and flexibly applicable design.

It is understood that other configurations of a rectifier arrangement can also fulfill the intended function and that the present invention is therefore not limited to the present embodiment according to FIGS. 1 and 2.

FIGS. 3A and 3B show exemplarily a cross-section of an umbrella valve 24, with FIG. 3A showing the umbrella valve 24 in a closed state (also referred to as blocking state) and FIG. 3B showing the umbrella valve in an open state. The umbrella valve 24 comprises an umbrella 21 and a fastening element 22. The umbrella valve 24 is configured such that the fastening element 22 is inserted through a fastening hole in the substrate 11 of the rectifier arrangement and is thus held in position. The umbrella 21 covers one or more through-holes 23 formed in the substrate 11. The through-holes can connect a first plane of the channel system 30 to a second plane of the channel system 30.

The arrows shown indicate the direction of flow of a liquid relative to the umbrella valve 24. When the liquid impinges on the side of the umbrella 21 facing away from the through-holes 23 (cf. FIG. 3A), the umbrella 21 will be pressed onto the through-holes 23 by the liquid pressure. The through-holes 23 are thus sealed and the flow of liquid is blocked. The umbrella valve 21 is in a blocking state. The opposite case is shown in FIG. 3B. When the liquid impinges on the umbrella side facing the through holes 23, the umbrella 21 is pushed away from the substrate 11 by the liquid pressure and the liquid can flow around the umbrella 21. The umbrella valve is in an open state.

Components of the umbrella valve 24, in particular the umbrella 21, may consist of an elastic material or include an elastic material. A suitable material is, for example, an elastomer material, such as silicone, liquid silicone rubber, fluorosilicone, nitrile rubber or neoprene, or a suitable combination thereof. An umbrella valve is a passive check valve. As described above, umbrella valves with through-holes located under the umbrella have the advantage of reducing bubble formation. Furthermore, umbrella valves are a cost-effective option for use as a check valve.

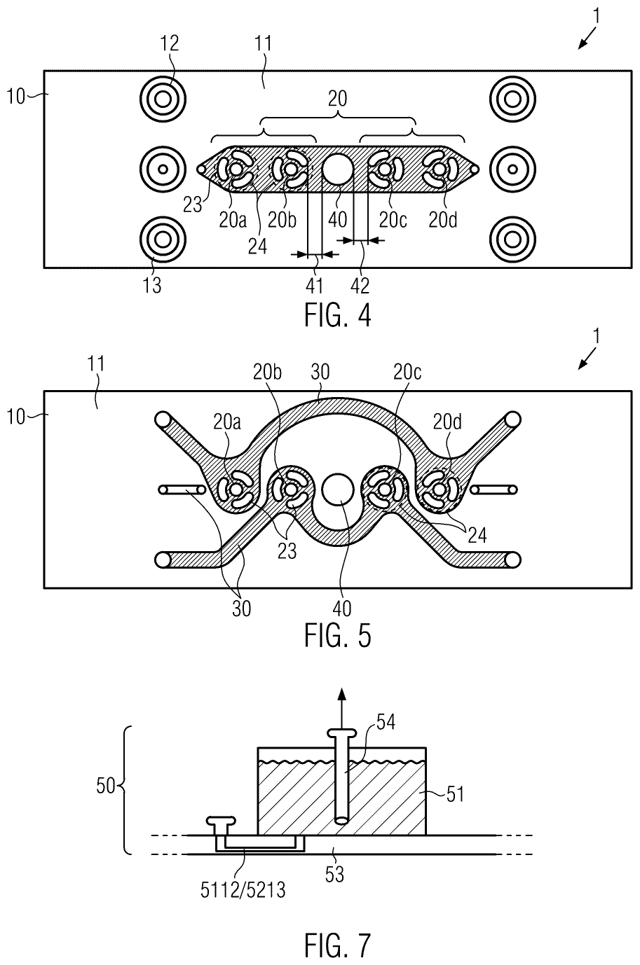

FIGS. 4 and 5 show a cross-sectional view of a second embodiment of the microfluidic device 1, with FIG. 4 showing the upper side and FIG. 5 showing the lower side. The explanations given above for the first embodiment also apply, in the same or in an analogous manner, to this second embodiment, since the embodiments are very similar to a large extent. Therefore, only the differences between the two embodiments will be pointed out below.

The substrate 11 has also formed therein a flow chamber 40. The latter may be configured both in the form of a through-hole or in the form of a well, provided in particular in the upper side. The fluid channel arrangement, in particular the channel system 30, are largely identical to the first embodiment, so that the liquid path is also very similar. Depending on whether the liquid is supplied at the first inlet opening 12 or the second inlet opening 13, the liquid passes through the valve 20a or 20b to the upper side (first plane) and flows over the flow chamber 40, so that an exchange of liquid takes place in the flow chamber 40. The liquid then passes on through the valve 20c or 20d to the second inlet opening 13 and the first inlet opening 12, respectively.

The area between the valve 20b and the flow chamber 40 can be considered as an inlet 41 and the area between the flow chamber 40 and the valve 20c can be considered as an outlet 42. Furthermore, the valves 20a and 20b (depending on where the liquid enters the first plane, when it is supplied at the first inlet opening 12 or the second inlet opening 13) also assume the role of the first rectifier opening 14. Analogously, it follows that the valves 20c and 20d assume the role of the second rectifier opening 15 accordingly.

This embodiment combines the flow chamber 40 and the rectifier unit 10 on a joint substrate. This compactifies the entire set-up. Another advantage is that no hoses or the like are needed as a liquid connection between the fluid channel arrangement and the flow chamber 40. This means that the liquid need not be transported through a possible temperature gradient, and this further reduces the risk of bubble formation in the liquid. In addition, the hoses would create dead volume, which is avoided here, whereby the required amount of liquid is reduced.

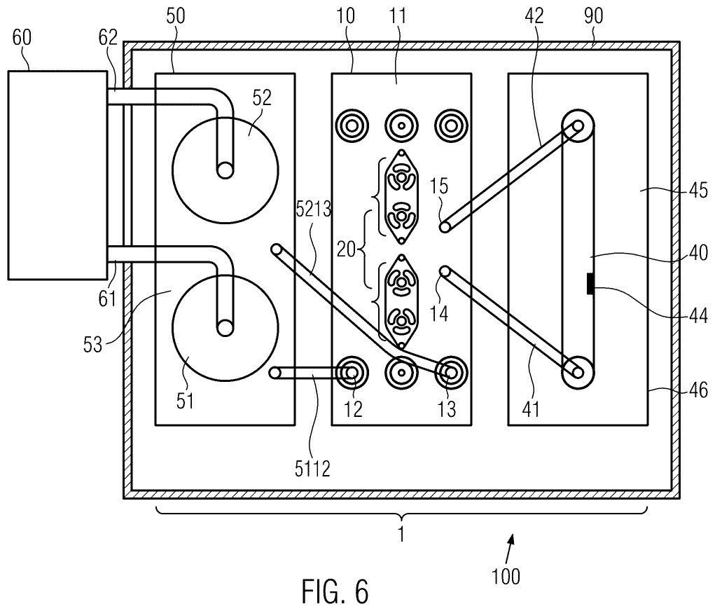

FIG. 6 illustrates an improved microfluidic system 100 according to the present invention. The microfluidic system 100 comprises a microfluidic device 1 as described above, with a rectifier unit 10, a flow chamber unit 46, a supply unit 50 and a compressed air unit 60. The rectifier unit 10, the flow chamber unit 46 and the supply unit 50. The microfluidic device 1 is arranged in an incubator 90. In principle, the microfluidic device 1 in the form described in the present example can also be considered as an independent entity that falls under the present invention.

The rectifier unit 10 may be a previously described rectifier unit 10.

The flow chamber unit 46 comprises a flow chamber 40, as well as an inlet 41 and an outlet 42. The inlet 41 is fluidically connected to the first rectifier opening 14 of the rectifier unit 10 and the outlet 42 is fluidically connected to the second rectifier opening 15 of the rectifier unit 10. The flow chamber unit 46 comprises a separate substrate 45. However, it is also possible that the flow chamber unit 46 is formed in the same substrate 11 as the rectifier unit 10, or that the substrate 11 and the substrate 45 are connected to form a joint substrate.

In addition, the flow chamber unit 46 includes a sensor 44 for measuring an oxygen concentration of the liquid in the flow chamber 40. The oxygen sensor can be read out optically from outside the flow chamber 40 because the sensor exhibits a change in fluorescence depending on the oxygen concentration of the liquid. Insofar, it can be an optically readable sensor.

The sensor 44 can interact with the gas mixer, so that a control loop is formed. For this purpose, the sensor 44 transmits a measured value to the gas mixer. The gas mixer then generates a gas mixture in such a way that the oxygen content of the liquid is adjusted to a predetermined value. This process can be carried out continuously, so that a control loop is formed.

Furthermore, the microfluidic device 1 includes a supply unit 50 with a first liquid reservoir 51 and a second liquid reservoir 52. The first liquid reservoir 51 and the second liquid reservoir 52 are formed in or on a substrate 53, which is also part of the supply unit 50. The first liquid reservoir 51 is fluidically connected to the first inlet opening 12 via a connection, for example a hose connection 5112. The second liquid reservoir 52 is fluidically connected to the second inlet opening 13 via a connection, for example a hose connection 5212.

Finally, the microfluidic device 1 includes a compressed air unit 60. The compressed air unit 60 is configured to provide compressed air so that the liquid can be pumped from the first liquid reservoir 51 through the fluid channel arrangement in the rectifier unit 10 in the direction of the second liquid reservoir 52, and in the opposite direction. This means that the liquid is pumped back and forth practically in a closed circuit between the first liquid reservoir 51 and the second liquid reservoir 52, without any need for supplying further liquid from outside. In this way, a closed system can be realized, which is protected from potential contamination by external influences. For this purpose, the compressed air unit 60 has air hoses 61, 62, which are connected to the first liquid reservoir 51 and the second liquid reservoir, respectively, in an optionally gas-tight manner. The compressed air unit 60 may be, or may include, an air pressure pump, a piston pump, a diaphragm pump, a peristaltic pump, a syringe or a syringe pump, so as to apply compressed air to the first liquid reservoir 51 and/or the second liquid reservoir 52.

The use of a compressed air unit, which, by means of an air column, is physically separated from a liquid circuit in the microfluidic system between the first liquid reservoir and the second liquid reservoir, additionally provides the advantage that the liquid does not come into contact with parts of the compressed air unit. This would be the case, for example, if a liquid pump were used for delivering the liquid. A potential contamination of the liquid can be avoided in this way.

As shown, the supply unit 50 includes a substrate 53, which is separate from the substrate 11 of the rectifier unit 10. However, it is conceivable that the two substrates 11 and 53 are connected to form a joint substrate. In this case, the microfluidic device can be configured to be even more compact and can be produced more easily, i.e. in one piece.

As far as described, the microfluidic device 1 comprising the four said components (rectifier unit 10, flow chamber unit 46, supply unit 50 and compressed air unit 60) can represent an independent entity that falls under the present invention.

In the flow chamber 40, e.g. cells or cell aggregates may be present, which are cultured under a continuous and unidirectional flow. Furthermore, observation of these cells under a microscope may be provided. For this purpose, the flow chamber unit 46 can be viewed under a microscope, optionally an inverse microscope.

A microfluidic system 100 according to the present invention is formed, when one of the above described microfluidic devices 10, with the exception of a possibly provided compressed air unit 60, is placed in an incubator 90. An incubator is a closed and controllable space that can be tempered, gassed and humidified, so that constant and/or controllable conditions will prevail even over long periods of time. The compressed air unit 60 should not be located in the incubator because waste heat that may originate from a pump or similar components provided in the compressed air unit 60 may affect the climate in the incubator 90.

The system thus combines the advantages of the microfluidic device, which have already been described, with the favorable properties of the incubator. These advantages include the provision of adjustable ambient conditions, which are constant in time, for an advantageous examination of living cells under physiologically relevant conditions. It is conceivable to observe the incubator with the microscope. This will additionally allow microscopic examination of the cultured cells.

Also a system comprising the described microfluidic system and the described flow chamber system is conceivable. In such a system, it is possible to simulate organ models and carry out examinations at the same time. The microfluidic system provides the perfusion with liquid. The flow chamber system offers the flow chamber in which the conditions are created and simulated as in a natural organ. For example, a specific oxygen concentration is generated via the gas mixer, which is intended to simulate the hypoxic conditions in the intestine. In this way, complex natural systems, such as human organs, can be simulated and examined in a compact set-up.

FIG. 7 shows the cross-section of a supply unit 50 according to the present invention. The supply unit 50 comprises a substrate 53, a first liquid reservoir 51, a second liquid reservoir 52, with only one liquid reservoir 51 being shown in the Figure for illustrative purposes. The liquid reservoir 51 comprises a supply line 5112/5213 for supplying and discharging liquid from the liquid reservoir 51 (note that the connection 5112/5213 performs the function). The supply line can be formed in the substrate 53. The liquid reservoir 51 is here formed on the substrate 53, but, in principle, it may also be formed in the substrate 11 of the rectifier unit 10 of the microfluidic device 1. Furthermore, the supply unit 50 includes a line 54 that leads from the outside into the interior of the liquid reservoir 51. In this case, the line 54 can extend e.g. through a cover or a sidewall into the interior of the liquid reservoir 51. In the case shown, the line 54 is a tube that is conducted through the cover. If a liquid is present in the interior of the liquid reservoir 51, as also indicated in the Figure, the tube 54 will extend into the liquid.

The line 54 may be a rigid tube. The line 54 may also be a flexible hose. Likewise, the line 54 may be composed of a rigid tube and a flexible hose.

Moreover, the line 54 may be connected to a gas source via a gas-tight connection, for example a suitable hose. In particular, the gas source (not shown) may comprise a gas mixer. The gas mixer may be adapted to generate a gas mixture containing particular percentages of individual gases (e.g. oxygen, nitrogen, carbon dioxide, etc.). This gas mixture is then conducted via the connection and the line 54 into the liquid reservoir 51. This allows the gas content of the liquid to be controlled. For example, the oxygen content of the liquid can be reduced, when a gas mixture is introduced that contains a reduced percentage of oxygen. Reduced percentage refers in particular to a percentage that is lower than the oxygen percentage prevailing in the surroundings, for example in air with an oxygen percentage of about 21%. A gas mixture with a reduced percentage of oxygen may therefore, for example, have an oxygen content of less than 21%.

The supply unit 50 can be used in particular in combination with the microfluidic device described. For this purpose, the substrate 53 may, for example, correspond to the substrate 11 of the microfluidic device 1, so that the components described are provided in a joint substrate 11 of the microfluidic device 1. Alternatively, the supply unit 50 may be provided separately from the above described microfluidic device 1. In this case, the supply line 5112/5213 may be connected to the first rectifier opening 14, as shown in FIG. 6. The same applies to the second liquid reservoir 52 and the second rectifier opening 15.

One possible implementation is so conceived that a gas mixture generated by the gas mixer is conducted to the compressed air unit 60. The compressed air unit then conducts the gas mixture under pressure via the line 54 into the respective liquid reservoir. Optionally, an additional outlet may be provided on the first liquid reservoir 51 and/or the second liquid reservoir 52. This additional outlet is configured for pressure equalization, since otherwise the liquid could be forced by the pressure from the compressed air unit through the connection 5112/5213 in the direction of the rectifier unit 10.

1. A microfluidic device comprising a rectifier unit, the rectifier unit comprising:
a substrate,
a valve assembly formed in the substrate, and
a fluid channel arrangement formed in the substrate, comprising:
a first inlet opening and a second inlet opening,
a first rectifier opening and a second rectifier opening, and
a channel system,
wherein the channel system fluidically connects the first inlet opening via the valve assembly to the first rectifier opening and fluidically connects the second inlet opening via the valve assembly to the second rectifier opening, or
wherein the channel system fluidically connects the first inlet opening via the valve assembly to the second rectifier opening and fluidically connects the second inlet opening via the valve assembly to the first rectifier opening,
wherein the valve assembly is adjustable from a first state into a second state, wherein in the first state a liquid is conveyable from the first inlet opening to the first rectifier opening and from the second rectifier opening to the second inlet opening, and wherein in the second state the liquid is conveyable from the second inlet opening to the first rectifier opening and from the second rectifier opening to the first inlet opening,
wherein the valve assembly comprises four valves, one of which is an umbrella valve having a through-hole formed under an umbrella of the umbrella valve, the through-hole being covered by the umbrella in a blocking state of the valve.

2. The microfluidic device according to claim 1, wherein
the channel system is arranged in a first plane and a second plane,
wherein the first plane is defined parallel to the second plane, and
wherein the first plane and the second plane are fluidically connected to each other by at least one of the valves of the valve assembly.

3. The microfluidic device according to claim 1, wherein each valve of the valve assembly is an umbrella valve.

4. The microfluidic device according to claim 2, wherein two of the valves are configured to block a flow from the first plane into the second plane and the other two of the valves are configured to block the flow from the second plane into the first plane.

5. The microfluidic device according to claim 1, wherein precisely two, three, four or five through-holes are arranged under the umbrella of each umbrella valve, and wherein a cross-section of these through-holes corresponds in particular to a circular ring segment with rounded corners.

6. The microfluidic device according to claim 1, wherein a length of a channel system portion connecting the first inlet opening to the first rectifier opening is identical to the length of a channel system portion connecting the second inlet opening to the second rectifier opening, and/or
wherein the length of a channel system portion connecting the first inlet opening to the second rectifier opening is identical to the length of a channel system portion connecting the second inlet opening to the first rectifier opening.

7. The microfluidic device according to claim 1, further comprising a supply unit with a first liquid reservoir and a second liquid reservoir,
wherein the first inlet opening is fluidically connected to the first liquid reservoir and the second inlet opening is fluidically connected to the second liquid reservoir.

8. The microfluidic device according to claim 7, wherein
the supply unit comprises a supply substrate,
wherein the first liquid reservoir and/or the second liquid reservoir is/are formed in and/or on the supply substrate.

9. The microfluidic device according to claim 7, wherein the first liquid reservoir and/or the second liquid reservoir additionally comprise(s) a line that extends from an outside into an interior of the respective liquid reservoir,
wherein the line extends in particular through a cover or through a sidewall of the respective liquid reservoir.

10. The microfluidic device according to claim 1, further comprising a flow chamber,
wherein the flow chamber comprises an inlet and an outlet, and
wherein the inlet of the flow chamber is fluidically connected to the first rectifier opening, and the outlet of the flow chamber is fluidically connected to the second rectifier opening.

11. The microfluidic device according to claim 10, wherein the flow chamber is formed in the substrate.

12. The microfluidic device according to claim 10, further comprising a sensor for measuring an oxygen concentration of the liquid.

13. The microfluidic device according to claim 1, wherein the substrate comprises:
a bottom plate, a cover plate and a center plate,
wherein a lower side of the center plate facing the bottom plate has formed therein at least one trench and wherein an upper side of the center plate facing the cover plate has formed therein at least one trench,
wherein the bottom plate and the center plate as well as the cover plate and the center plate are areally connected to one another, so that the trench in the upper side is covered by the cover plate and the trench in the lower side is covered by the bottom plate, and
wherein covered trenches are part of the fluid channel arrangement.

14. The microfluidic device according to claim 13, wherein the cover plate comprises a first film, and/or
wherein the bottom plate comprises a second film, and/or
wherein the cover plate and/or the bottom plate is/are transparent in a visible spectral range.

15. The microfluidic device according to claim 7, further comprising a compressed air unit that is fluidically connected to the first liquid reservoir and the second liquid reservoir,
wherein the compressed air unit is configured and arranged for pumping, by means of compressed air, a liquid from the first liquid reservoir through the fluid channel arrangement in a direction of the second liquid reservoir, and in the opposite direction.

16. A microfluidic system comprising:
a microfluidic device comprising a rectifier unit that comprises:
a substrate,
a valve assembly formed in the substrate, and
a fluid channel arrangement formed in the substrate, comprising:
a first inlet opening and a second inlet opening,
a first rectifier opening and a second rectifier opening, and
a channel system,
wherein the channel system fluidically connects the first inlet opening via the valve assembly to the first rectifier opening and fluidically connects the second inlet opening via the valve assembly to the second rectifier opening, or
wherein the channel system fluidically connects the first inlet opening via the valve assembly to the second rectifier opening and fluidically connects the second inlet opening via the valve assembly to the first rectifier opening,
wherein the valve assembly is adjustable from a first state into a second state, wherein in the first state a liquid is conveyable from the first inlet opening to the first rectifier opening and from the second rectifier opening to the second inlet opening, and wherein in the second state the liquid is conveyable from the second inlet opening to the first rectifier opening and from the second rectifier opening to the first inlet opening, and
wherein the valve assembly comprises four valves, one of which is an umbrella valve having a through-hole formed under an umbrella of the umbrella valve, the through-hole being covered by the umbrella in a blocking state of the valve, and
an incubator,
wherein the microfluidic device is arranged inside the incubator in such a way that a liquid circuit of the microfluidic device is located fully inside the incubator.

17. A method comprising:
providing a microfluidic device comprising a rectifier unit that comprises:
a substrate,
a valve assembly formed in the substrate, and
a fluid channel arrangement formed in the substrate, comprising:
a first inlet opening and a second inlet opening,
a first rectifier opening and a second rectifier opening, and
a channel system,
wherein the channel system fluidically connects the first inlet opening via the valve assembly to the first rectifier opening and fluidically connects the second inlet opening via the valve assembly to the second rectifier opening, or
wherein the channel system fluidically connects the first inlet opening via the valve assembly to the second rectifier opening and fluidically connects the second inlet opening via the valve assembly to the first rectifier opening,
wherein the valve assembly is adjustable from a first state into a second state, wherein in the first state a liquid is conveyable from the first inlet opening to the first rectifier opening and from the second rectifier opening to the second inlet opening, and wherein in the second state the liquid is conveyable from the second inlet opening to the first rectifier opening and from the second rectifier opening to the first inlet opening, and
wherein the valve assembly comprises four valves, one of which is an umbrella valve having a through-hole formed under an umbrella of the umbrella valve, the through-hole being covered by the umbrella in a blocking state of the valve,
providing a liquid at the first inlet opening and pumping the liquid through the fluid channel arrangement in a direction of the second inlet opening, and
reversing a direction of pumping by pumping the liquid through the fluid channel arrangement in the direction of the first inlet opening.

18. The method according to claim 17, wherein steps of providing the liquid and reversing the direction of pumping are controlled by means of compressed air.

19. The method according to claim 17, further comprising:
incubating the microfluidic device in an incubator (90), where a liquid circuit of the microfluidic device is located fully inside the incubator.
